(19) United States
(12) Patent Application Publication
(10) Pub. No.: US 2009/0272852 A1
(43) Pub. Date: Nov. 5, 2009

(54) Aerial Delivery Device

(75) Inventors: Brad Michael Reynolds, Invercargill (NZ); Matthew John Joseph Keppel, Invercargill (NZ)

Correspondence Address: JOHN ALEXANDER GALBREATH, 2516 CHESTNUT WOODS CT, REISTERSTOWN, MD, 21136, US

(73) Assignee: CONCEPT SOLUTIONS LIMITED, Invercargill (NZ)

(21) Appl. No.: 12/305,018

(22) PCT Filed: Jul. 13, 2007
(86) PCT No.: PCT/NZ2007/000181

§ 371 Date: Dec. 16, 2008

(30) Foreign Application Priority Data
Jul. 20, 2006 (NZ) 546684

(51) Int. Cl. B64D 19/02; B64D 1/02

(52) U.S. Cl. 244/138 A

(57) ABSTRACT

An aerial delivery device which includes a carrier configured to carry an item for delivery, and one or more wings attached to the carrier and arranged to extend therefrom; wherein said aerial delivery device is configured to provide a controlled aerial descent under gravity, such that during the descent the aerial delivery device, or the or each wing, auto rotates.

### FIELD OF THE INVENTION

The present invention relates to an aerial delivery or distribution device intended to deliver an item from a plane, balloon or similar to the ground safely. Such items may include poison containing receptacles, small collectable items or food items.

### BACKGROUND

Often to deliver an item to a particular location requires it is delivered aerially; this may be because of access, cost, speed, distribution pattern required, or other reasons. A further problem arises when the site has no runway or landing area, or due to cost or timing no landing is feasible; this can require the item is dropped. Each item dropped will impact the ground and, depending on the item, suffer varying degrees of damage. To minimise the damage some items employ descent or shock protection devices to slow the descent or absorb the impact of landing respectively. For example some low level food drops package each food parcel in shock absorbing packaging, whereas pest poison drops just allow the pellets to fall, landing where they may.

The reason for using aerial drops for poison bait is that the alternatives often involve checking of the bait station or traps; this leads to contamination by human scent, which the target pests avoid. This means that aerial distribution is preferred as little human contamination of the targeted area occurs and the pests are more inclined to take the bait dropped. However traditional aerial poison bait drops have problems as the target pests can very quickly learn that the poison bait dropped is not safe and therefore they avoid it. In addition some target pests have learnt that if the bait is not in a form normally available then it should be avoided, for example carrots are not normally found lying on the ground. This can reduce the effect of poison bait drops, and may in fact rule them out as cost effective methods. Further, much of the aerially distributed poison bait can land on the forest floor which may be away from the normal food sources of the targeted pests. Egg eating pests often seek their food in the forest canopy thus are not targeted by the low lying bait. A further problem with poison bait drops is that non targeted species can consume the poison bait and die; this may include native and endangered species.

Aerial delivery is also appropriate for other commercial applications, for example with increasing competition in the retail sector more companies are distributing free samples and promotional materials, some include prizes. One company went to the extent of aerially dropping many hundreds of marshmallows, one with a diamond ring inside it. These marshmallows were not wrapped nor protected from harm in any way, they also could not be printed with any promotional material. Therefore the value of the promotion was gained by additional advertising and media coverage of the event. The risk of food poisoning from consuming the marshmallows was also present. At other events lolly scrambles with wrapped sweets occurs, these are often hard toffees in waxed paper or plastic wrappings. There is a danger of injury from the falling sweets and a waste management issue from the non-biodegradable wrappings, which are often just discarded.

### OBJECT OF THE INVENTION

It is therefore an object of the invention to provide a device that can be distributed aerially that can carry an item to the ground so that it arrives in a useable form. Further objects of the invention include one or more of the following:
1. The ability to carry warning, identification, advertising, promotional or other printed material on its surfaces.
2. To minimise the environmental impact of aerial distribution.
3. To provide a cost effective and useful alternative to the products already on the market.
4. To distribute a fragile poison container.
5. To deliver a poison bait above the forest floor.
6. Reduce the possibility that poison bait is consumed by a non target species.
7. To provide poison bait in a form accepted by the target species.
8. To carry colour, patterning, scents or other materials to attract the target species.

The present invention provides an aerial delivery device which includes a carrier configured to carry an item for delivery, and one or more wings attached to the carrier and arranged to extend therefrom; wherein said aerial delivery device is designed to provide a controlled aerial descent under gravity.

Preferably the aerial delivery device, or the or each wing, auto rotates during descent.

Preferably the carrier and the item form a single object.

Preferably during the descent the aerial delivery device, or the or each wing, auto rotates. In a highly preferred form the aerial delivery device or the or each wing freely rotates about a point located within or near the aerial delivery device. In a still more preferred form the point is located in or near the carrier.

In a highly preferred form the carrier includes a first section and second section, releasably securable together by a locking means; wherein each section includes a pocket which is an indentation in a planar surface of the respective section; the sections are adapted to be releasably connected with their respective planar surfaces in contact by the locking means, said pockets combining to form a void within the carrier, the void being dimensioned to contain the item.

In a highly preferred form the or each wing and the first section are rigidly connected. Preferably the planar surface of the first section is parallel to the width of the or each wing. In a highly preferred form the first and second sections are releasably hinged together such that said hinge is adapted to move the sections exposing the pockets.

Preferably the item to be carried is an egg, said egg being an artificial egg that includes a wall and a food source. The wall is adapted to retain the food source within the egg. Preferably said wall is one or more layers of impermeable or semi-permeable material, such as gelatine, coated gelatine, fats, oils, polymer membranes, starches and the like. Preferably the egg is ovoidal or spheroidal in shape with one axis being dimensioned to allow a target species to grip or bite the egg. In a highly preferred form the wall of the egg is dimensioned to prevent non-target species from accessing the food source. Preferably said egg is constructed of materials similar or identical to real eggs, for example albumin, crushed eggshell, yolk, Calcium Carbonate, Calcium Phosphate, etc. In a highly preferred form the food source contains one or more of the following albumin, yolk, poison, attractants, repellents, protein sources, sugars, endorphins and hormones.

In a second embodiment it is preferred that the or each wing includes an aperture in a planar section of the wing, such that said aperture is adapted to releasably engage with a matching groove in the carrier. In a highly preferred form the aperture is adapted to allow the or each blade to move about the carrier as the aerial delivery device descends. In a further preferred form the carrier includes a gyroscope adapted to prevent the carrier from turning with the aerial delivery device.

In a further preferred form the aerial delivery device is directly printed with advertising, warning messages, information, identifying marks, contact details or similar. It is further preferred that the carrier or wing includes a means to generate an electric current that can be used and/or stored for later use, by the item or additional devices within the aerial delivery device. Preferably the additional devices include lights, transmitters, heaters and sound generators.

Preferably one or more parts of the aerial delivery device are made of mashed vegetables, an edible material, paper products, biodegradable polymeric materials, biodegradable synthetic materials, biodegradable natural materials or similar. In a highly preferred form the aerial delivery device is made of mashed vegetable matter, including the hinge and or locking means.

In a further preferred form the item is chosen from a gift, a promotional device, an electronic device, printed matter, a food product and a chemical product.

By way of example only a preferred embodiment of the invention will now be described in detail with reference to the accompanying drawings in which:

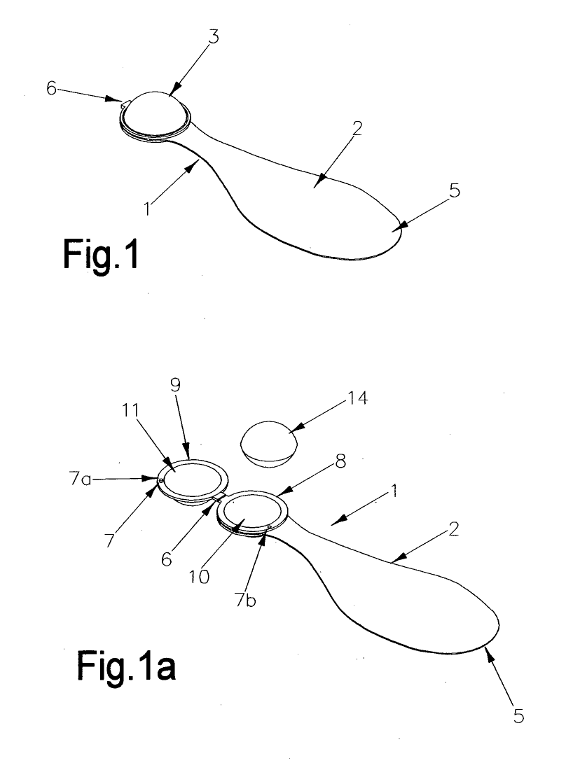

FIG. 1 is a pictorial view of a first embodiment of the aerial delivery device in the closed position.

FIG. 1a. is an exploded pictorial view of the first embodiment of the aerial delivery device and egg in the open position.

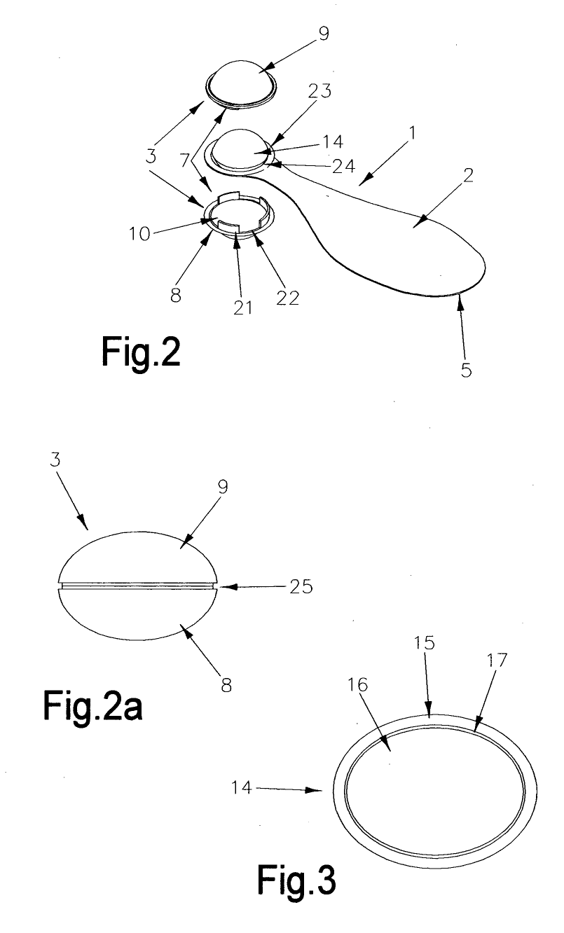

FIG. 2 is an exploded pictorial view of a second embodiment of the aerial delivery device, with egg included.

FIG. 2a is a side view of the carrier of the second embodiment in the closed position.

FIG. 3 is a cross sectional view of a egg carried by the aerial delivery device.

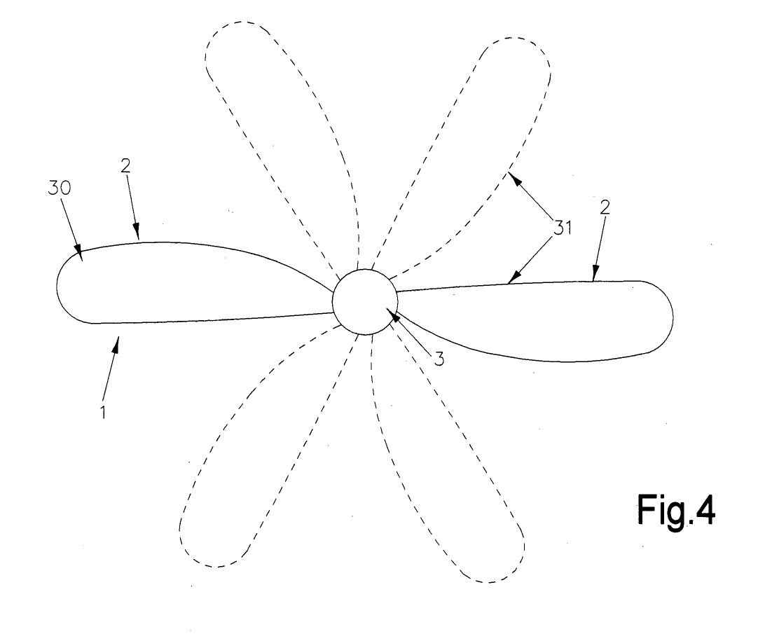

FIG. 4 is a pictorial view of the aerial delivery device with more than one wing.

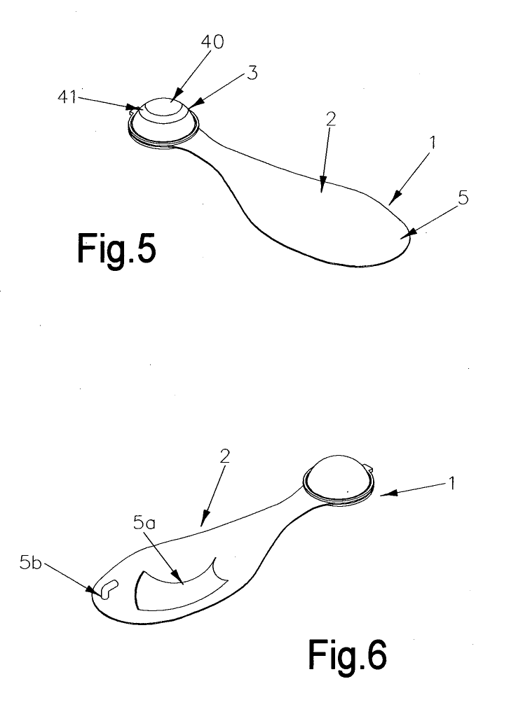

FIG. 5 is a pictorial view of the second embodiment of the aerial delivery device with a gyroscope in the carrier.

FIG. 6 is a pictorial view of the aerial delivery device with an aperture and a barb.

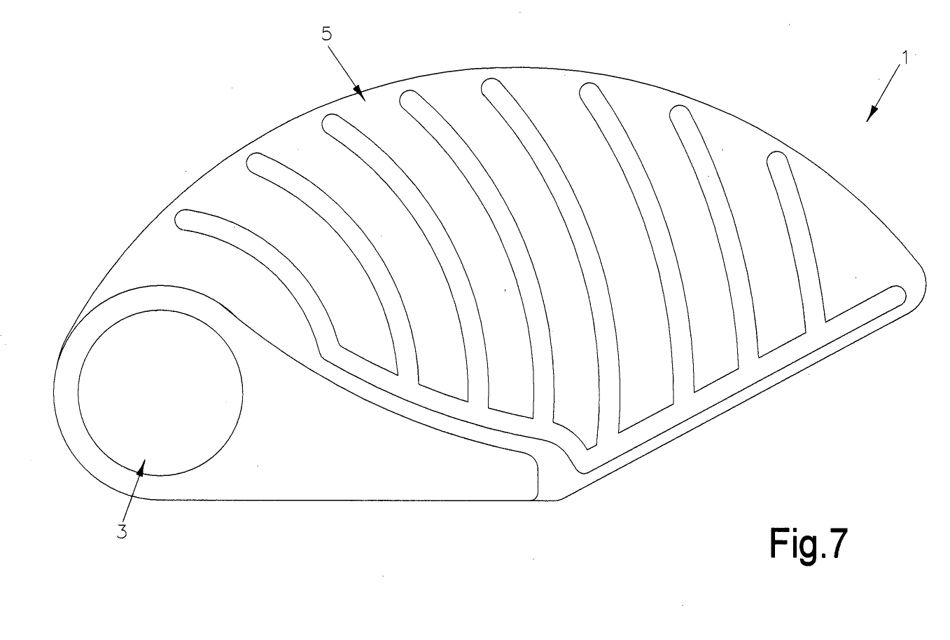

FIG. 7 is a plan view of the aerial delivery device with an alternative wing shape.

Referring to FIGS. 1 and 1a an aerial delivery device (1) is shown, said delivery device (1) includes a wing (2) and a carrier (3). The carrier (3) is a hollow casing substantially spheroidal in shape with its longest axis parallel to the width of the wing (2).

The wing (2) is connected to, and extends radially from, the surface of the carrier (3). The wing (2) is a thin flat blade with a broad rounded distal end (5), which is dimensioned and shaped such that in use it slows the descent of the aerial delivery device(1). Said wing (2) may be planar or profiled in three dimensions to provide the desired descent velocity, which may vary depending upon the item carried. The wing (2) may include apertures (5a), extensions (5b), barbs or similar adapted to catch on foliage and branches, so that the aerial delivery device (1) is caught in the canopy of the forest or bush.

The carrier (3) further includes a flexible flap (6), a locking means (7), a first section (8), which is connected to the wing (2), and a second section (9). The first section (8) and second section (9) are the parts of the carrier (3) formed when the carrier (3) is bisected by a plane whose surface is parallel to the longest axis of the carrier (3). Each section (8,9) includes a pocket, a first pocket (10) and a second pocket (11) in the first and second sections (8,9) respectively. Each pocket (10,11) is a concave indentation in the planar surface of the respective section (8,9). The locking means (7) includes a locking pin (7a) that is located adjacent the second pocket (11) and releasably engages with a matching locking socket (7b) adjacent the first pocket (10).

The first and second sections (8,9) are hinged together by the flexible flap (6) which is adapted to allow the carrier (3) to move from an open position, with the pockets (10,11) exposed, to a closed position, where the pockets (10,11) are not exposed, and back.

The first pocket (10) and second pocket (11) in the closed position form an ovoidal or spheroidal cavity within the carrier (3); said cavity is adapted to releasably carry an artificial egg (14).

Referring to FIG. 3, the egg (14) is shown in detail. The egg (14) is a sealed hollow ovoid or spheroid which includes a wall (15) and a food source (16). The wall (14) forms the surface of the egg (14) and surrounds the food source (16) protecting it from the environment. The minor axis of the egg (14) is dimensioned to allow the jaws of the target animal to grip or bite the egg (14). The wall (15) is dimensioned to allow the target species access to the food source (16) within the egg (14) but prevent access by other species, where this is possible. For example the shape and thickness of the egg could prevent the beak of a native bird from penetrating the wall (15) but allow the slower sustained pressure applied by a stoat's teeth to penetrate. The shape of the egg (14) may cause the single impact point of the bird's beak to slide off the wall (15).

The wall (15) includes a membrane (17) that is impermeable or semi-permeable to the food source (16); said membrane is the wall (15) surface in direct contact with the food source (16). The membrane (17) acts as a protective seal for the food source (16) extending its storage and field life. The membrane (17) may be permeable to only certain scent compounds within the food source (16) known to attract the target species. The materials used for the wall (15) and food source (16) are as close to those of a natural egg as possible; for example the shell can be made of crushed eggshell with an albumin binder.

The wing (2), carrier (3) and wall (15) may be made of an edible material, with colours or scents attractive to specific species. This edible material may be poisoned, and different parts of the aerial delivery device (1) may be targeted at different species. For example if a secondary species is at risk from the poison drop, providing an unpoisoned wing may prevent the consumption of the poisoned components.

To minimise the environmental impact of the aerial delivery device (1) certain components may be made of natural or biodegradable materials. For example the whole of the wing (2), and carrier (3) may be made of a papier mache like material made from carrot/turnip/beet or similar with a starch binder. Alternatively a water soluble material may be used so that the egg (14) is left exposed shortly after landing. In a single drop, different aerial delivery devices (1) could be constructed from different materials so that the eggs (14) become accessible to the target species over a period of time.

Referring to FIGS. 2 and 2a a second embodiment of the aerial delivery device (1) is shown. In this embodiment the wing (2), the first section (8) and the second section (9) are separate components. In this embodiment the locking means (7) consists of one or more clips (21) and one or more sockets (22), that extend from, or are indentations in the planar surface. Each clip (21) in the first section (8) is adapted to releasably engage with a matching socket (22) in the second section (9), and vice versa. When engaged the clips (21) and sockets (22) releasably connect the sections (8,9) together. These clips (21) and matching sockets (22) can for example be a flexible strip with a tooth that engages with a groove in the socket (22).

The wing (2) includes a connecting section (23) and an aperture (24) wherein the aperture (24) is a hole in the connecting section (23). The connecting section (23) is a planar section at one distal end of the wing (2) whose surface lies parallel to the width of said wing (2).

The carrier (3) includes a groove (25) cut into its surface, such that half of the groove (25) is cut into each section (8,9) respectively. The groove (25) is parallel to the major axis of the carrier (3) and dimensioned to releasably connect with said aperture (24). The connection between the wing (2) and the carrier (3) locks the position of one in relation to the other.

To assemble the second embodiment the connecting section (23) is placed over the first section (8), such that the aperture (24) releasably engages with the part of the groove (25) in the first section (8). The egg (14) is then placed in the first pocket (10) and the second section (9) is connected to the first section (8). The clips (21) and sockets (22) of the first section (8) engage with the respective matching clips (21) and sockets (22) of the second section (9) to lock the sections (8,9) together. Once locked together the wing (2) is retained in the groove (25) and the egg (14) is within the carrier (3).

The wing (2) or carrier (3) can be printed with advertising, messages, warnings or other messages during manufacture. This printing can include the application of scents or other attractants, including inks that produce patterns in infra red or ultra violet light.

In a further embodiment as shown in FIG. 4 there is more than one wing (2) attached to the carrier (3), such that a first wing (30) is located in the same plane as, but directly opposite to, a second wing (31). Alternatively the second (31) or additional wings may be located in the same plane, but at any angle to, the first wing (30), as shown in dashed lines in FIG. 4.

In a further embodiment, as shown in FIG. 5, the carrier (3) includes a gyroscope (40) and/or stabilising means (41) to keep the egg (14) relatively stationary during its descent thus further protect the egg (14) from damage.

In a further preferred embodiment the carrier (3) contains an item such as a toy, golf ball, collectable, message, food product, advertising promotional, electronic device or similar instead of an egg (14). The wing (2) in this embodiment may be printed with promotional or identifying material making it valuable or collectable.

In a still further embodiment (not shown) the aerial delivery device includes a generator, power source or solar panel adapted to charge or run an electronic device held within the carrier for use or distribution upon landing.

In a further preferred embodiment (not shown) the carrier (3) and the egg (14), or item, form a single object, which may be hollow, filled or solid.

During the descent of the aerial delivery device (1), under gravity, the distal end (5) of the or each wing (5) moves along an approximately circular path about a point located within or near the aerial delivery device (1), that is the aerial delivery device (1) auto-rotates. In the second embodiment, as shown in FIGS. 2 and 2a, the aperture (24) is dimensioned to allow the or each wing (2) to rotate about the carrier (3) without imparting any significant rotational movement to the carrier (3). It should be noted that auto rotation occurs without any initial rotational motion necessarily being applied to the aerial delivery device (1).

Any discussion of the prior art throughout the specification is not an admission that such prior art is widely known or forms part of the common general knowledge in the field.

1. An aerial delivery device which includes a carrier configured to carry an item for delivery, and one or more wings attached to the carrier and arranged to extend therefrom; wherein said aerial delivery device is configured to provide a controlled aerial descent under gravity, such that during the descent the aerial delivery device, or the or each wing, auto rotates.

2. An aerial delivery device as claimed in claim 1, characterised in that the carrier includes a first section and second section, releasably securable together by a locking means; wherein each section includes a pocket which is an indentation in a planar surface of the respective section; the sections are adapted to be releasably connected with their respective planar surfaces in contact by the locking means, said pockets combining to form a void within the carrier, the void being dimensioned to contain the item.

3. An aerial delivery device as claimed in claim 2, characterised in that the planar surface of the first section is parallel to the width of the or each wing.

4. An aerial delivery device as claimed in claim 2, characterised in that the first and second sections are releasably hinged together such that said hinge is adapted to move the sections exposing the pockets.

5. An aerial delivery device as claimed in claim 1, characterised in that the or each wing and the first section are rigidly connected.

6. An aerial delivery device as claimed in claim 1, characterised in that the carrier and the or each wing form a single object.

7. An aerial delivery device as claimed in any one of claims 1, characterised in that the or each wing includes an aperture in a planar section of the wing, such that said aperture is adapted to releasably engage with a matching groove in the carrier.

8. (canceled)

9. (canceled)

10. An aerial delivery device as claimed in claim 1 in combination with an item to be carried by the carrier, characterised in that the item to be carried is an egg.

11. An aerial delivery device as claimed in claim 10, characterised in that the egg is an artificial egg that includes a wall and a food source, the wall is adapted to retain the food source within the egg.

12. An aerial delivery device as claimed in claim 11, characterised in that the wall is one or more layers of impermeable or semi-permeable material.

13. (canceled)

14. An aerial delivery device as claimed in claim 10, characterised in that the egg is ovoidal or spheroidal in shape with one axis being dimensioned to allow a target species to grip or bite the egg.

15. An aerial delivery device as claimed in claim 11, characterised in that the wall of the egg is dimensioned to prevent non-target species from accessing the food source.

16. An aerial delivery device as claimed in claim 11, characterised in that the egg is constructed of one or more material similar or identical to real eggs.

17. (canceled)

18. An aerial delivery device as claimed in claim 11, characterised in that the food source contains one or more ingredients selected from the list consisting of: albumin, yolk, poison, attractants, repellents, protein sources, sugars, endorphins and hormones.

19. An aerial delivery device as claimed in claim 1 in combination with an item to be carried by the carrier, characterised in that the item to be carried is selected from the list consisting of: a can, a chocolate product, a golf ball, a promotional item, a toy, an electronic device, a food product and a chemical product.

20. An aerial delivery device as claimed in claim 1, characterised in that one or more part of the aerial delivery device carries printed matter.

21. (canceled)

22. An aerial delivery device as claimed in claim 1, characterised in that the carrier and/or wing includes a means to generate an electric current that can be used and/or stored for later use, by the item or additional devices within the aerial delivery device.

23. (canceled)

24. An aerial delivery device as claimed in claim 1, characterised in that one or more parts of the aerial delivery device are made of a material selected from the group consisting of mashed vegetables, an edible material, paper products, biodegradable polymeric materials, biodegradable synthetic materials and biodegradable natural materials.

25. (canceled)

26. An aerial delivery device as claimed in claim 1, characterised in that there is only one wing.

27. (canceled)

28. An aerial delivery device as claimed in claim 3, characterised in that the first and second sections are releasably hinged together such that said hinge is adapted to move the sections exposing the pockets.

29. An aerial delivery device as claimed in claim 2, characterised in that the or each wing includes an aperture in a planar section of the wing, such that said aperture is adapted to releasably engage with a matching groove in the carrier.
